(19) United States
(12) Patent Application Publication
(10) Pub. No.: US 2015/0199702 A1
(43) Pub. Date: Jul. 16, 2015

(54) SYSTEMS AND METHODS FOR USING TRANSACTION DATA ASSOCIATED WITH A LOYALTY PROGRAM IDENTIFIER TO CONDUCT A PURCHASE TRANSACTION

(71) Applicant: Toshiba Global Commerce Solutions Holdings Corporation, Tokyo (JP)

(72) Inventor: Ankit Singh, Morrisville, NC (US)

(73) Assignee: Toshiba Global Commerce Solutions Holdings Corporation, Tokyo (JP)

(21) Appl. No.: 14/182,077

(22) Filed: Feb. 17, 2014

Related U.S. Application Data
(60) Provisional application No. 61/926,302, filed on Jan. 11, 2014.

(51) Int. Cl. G06Q 30/02; G06Q 30/06; G06K 9/00; G06Q 20/20

(52) U.S. Cl. CPC G06Q 30/0226; G06Q 20/20; G06Q 30/0607; G06K 9/00469; G06K 9/00295

(57) ABSTRACT

Systems and methods for using transaction data associated with a loyalty program identifier to conduct a purchase transaction are disclosed. According to an aspect, a method includes initiating a purchase transaction at a shopper terminal. The method also includes receiving, at the shopper terminal, a loyalty program identifier of a shopper. Further, the method includes associating the loyalty program identifier with transaction data for the shopper. The method also includes conducting the purchase transaction at the shopper terminal based on the transaction data.

### CROSS REFERENCE TO RELATED APPLICATION

This application claims the benefit of U.S. Provisional Patent Application No. 61/926,302, filed Jan. 11, 2014 and titled SYSTEMS AND METHODS FOR USING TRANSACTION DATA ASSOCIATED WITH A LOYALTY PROGRAM IDENTIFIER TO CONDUCT A PURCHASE TRANSACTION, the content of which is hereby incorporated herein by reference in its entirety.

### TECHNICAL FIELD

The present invention relates to conducting purchase transactions, and more specifically, to using transaction data associated with a loyalty program identifier to conduct a purchase transaction.

### BACKGROUND

In retail environments, such as grocery stores and other “brick and mortar” stores, customers often operate retail equipment such as point-of-sale (POS) equipment. For example, customers may interact with POS self-checkout equipment for conducting purchase transactions. Self-checkout equipment may include scanners for optically scanning bar codes affixed to products for purchase by a customer. In this way, products may be identified and subsequently the purchase transaction completed.

Other than product identification information, customers may also interact with POS equipment, either self-checkout equipment or otherwise, for entering other information for conducting a purchase transaction. For example, customers may interact with a user interface of the POS equipment for entering various personal selections. The steps of entering this information can significantly slow the overall transaction. For example, consider a customer who needs to make language selection, who is handicapped, who believes in paperless receipts, who uses the same financial card for all purchases, and/or who often purchases alcohol or other age restricted items. For such transactions, it may be very time consuming for the customer to enter all of the information for conducting the transaction. Therefore, for at least these reasons, it is desired to provide improved techniques and system for conducting purchase transactions.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for using transaction data associated with a loyalty program identifier to conduct a purchase transaction. According to an aspect, a method includes initiating a purchase transaction at a shopper terminal. The method also includes receiving, at the shopper terminal, a loyalty program identifier of a shopper. Further, the method includes associating the loyalty program identifier with transaction data for the shopper. The method also includes conducting the purchase transaction at the shopper terminal based on the transaction data.

According to another aspect, a method may be implemented at a shopper terminal. The method includes receiving photographic data associated with an individual meeting an age requirement for purchase of a product. The method also includes capturing an image of a shopper. Further, the method includes determining whether the shopper meets the age requirement based on the captured image and the photographic data. The method also includes permitting purchase of the product based on the determination of whether the shopper meets the age requirement.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of an example shopper terminal configured to operate according to embodiments of the present invention;

FIG. 2 is a flow chart of an example method for using transaction data associated with a loyalty program identifier to conduct a purchase transaction in accordance with embodiments of the present invention;

FIG. 3 is a flow chart of an example method for using transaction data associated with loyalty program identifier to conduct a purchase transaction in accordance with embodiments of the present invention; and

FIG. 4 is a flow chart of an example method in accordance with embodiments of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including one or more electronic components. For example, a computing device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

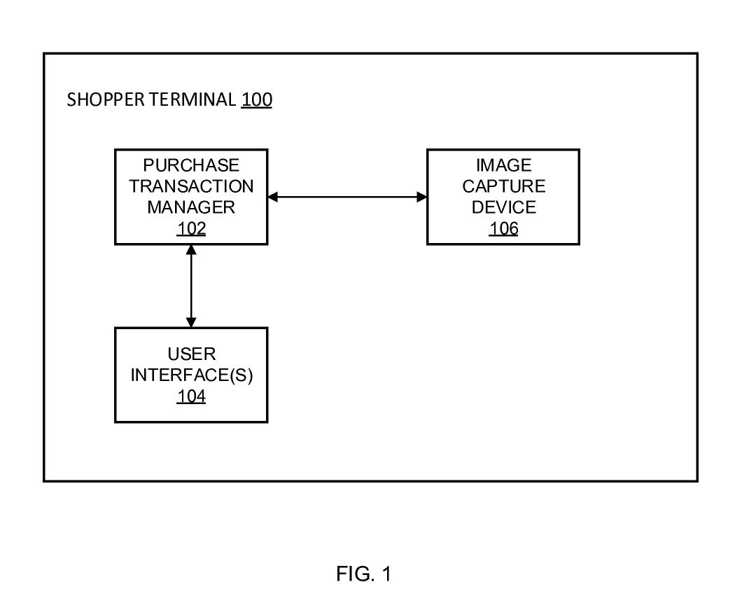

FIG. 1 illustrates a block diagram of an example shopper terminal 100 configured to operate according to embodiments of the present invention. The shopper terminal 100 may be within self-checkout environment, such as a retail store, for conducting purchase transactions. It is also noted that the shopper terminal may be any type of computing device configured to operate with a retail environment. For example, the shopper terminal may be one of several shopper terminals connected via one or more networks to a server. The server may provide retail management functions to the shopper terminals. Further, for example, the shopper terminal 100 may be configured to communicate to the server purchase transaction information or other data for implementing retail functions. The shopper terminal 100 may be configured to receive communications from the server related to retail functions. The shopper terminal 100 may include suitable network interface equipment for communicating with the server via the network.

Referring to FIG. 1, the shopper terminal 100 may include a purchase transaction manager 102 that can implement purchase transactions. The purchase transaction manager 102 may be implemented by hardware, software, firmware, or combinations thereof. For example, the purchase transaction manager 102 may be implemented by one or more processors and memory. The purchase transaction manager 102 may be configured to implement a point-of-sale (POS) application. The shopper terminal 100 may include one or more user interfaces 104 for interfacing with a shopper or store associate. For example, the user interface 104 may include a display. The shopper terminal 100 may communicate over one or more networks with network entities, such as financial institutions. Purchases may be made via the shopper terminal 100 whereby the shopper terminal 100 facilitates electronic funds transfers over network(s) between customer accounts for one or more financial institutions and an establishment that implements the shopper terminal 100 (i.e., a vendor).

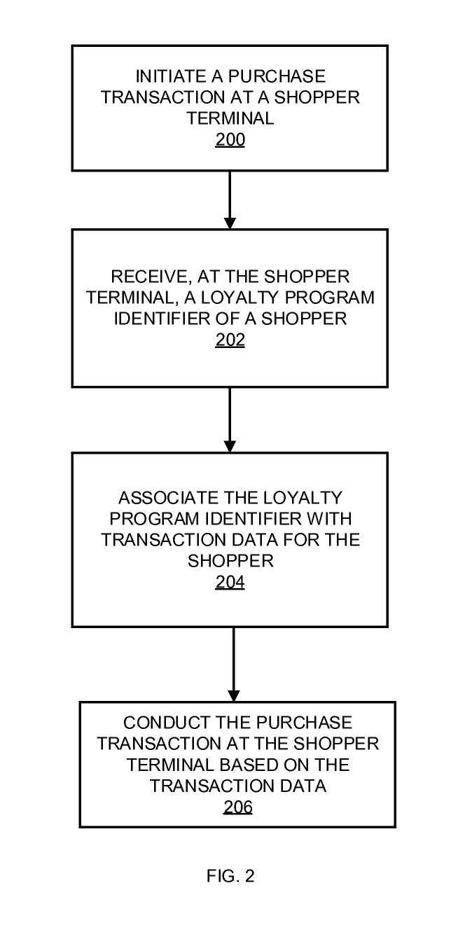

FIG. 2 illustrates a flow chart of an example method for using transaction data associated with a loyalty program identifier to conduct a purchase transaction in accordance with embodiments of the present invention. In this example, the method is described as being implemented by the purchase transaction manager 102 of the shopper terminal 100, although it should be recognized that the method may be implemented by any suitable computing device.

Referring to FIG. 2, the method includes initiating 200 a purchase transaction at a shopper terminal. For example, a shopper may gather one or more items or products within a retail environment and subsequently carry the item(s) to a shopper terminal, such as the shopper terminal 100, for purchase of the item(s). At the shopper terminal 100, the shopper may interact with the user interface 104 to initiate the purchase transaction. For example, the user interface 104 may include a touchscreen display, a keypad, or the like for receiving user input. In the example, of a touchscreen display, the display may present one or more icons or other user prompts for interaction by the user. A displayed icon may be a “start” button for touch or other selection by the shopper for initiating the purchase transaction. Alternatively, the shopper may push another button on the display or interact with the user interface 104 in any other suitable manner for initiating a purchase transaction at the shopper terminal. Subsequent to interaction by the shopper with the user interface 104, the user interface 104 may communicate data to the purchase transaction manager 102 for indicating the interaction. The purchase transaction manager 102 may suitably initiate the purchase transaction in response to receipt of the communication.

The method of FIG. 2 includes receiving 202, at the shopper terminal, a loyalty program identifier of a shopper. Continuing the aforementioned example, the user interface 104 may include a scanner, and the shopper may wave his or her loyalty program card in range of the scanner. The loyalty program card may include a loyalty program identifier of the shopper. The scanner may read the identifier, and communicate it to the purchase transaction manager 102. In another example, the user interface 104 may include a keyboard, keypad, touchscreen display, or the like for use by the shopper for entering loyalty program information. For example, the user may enter an alphanumeric identifier (e.g., a telephone number) indicating the loyalty program identifier.

The method of FIG. 2 includes associating 204 the loyalty program identifier with transaction data for the shopper. Continuing the aforementioned example, the purchase transaction manager 102 may associate the loyalty program identifier with transaction data for the shopper. The transaction data may be stored in memory of the shopper terminal 100 or in another computing device, such as a server, that is accessible by the shopper terminal 100. In an example, the shopper terminal 100 may communicate the loyalty program identifier to a remote server, and the remote server may perform a lookup for the transaction data based on the loyalty program identifier. Example transaction data may include preferred language information, accessibility mode, receipt information, electronic funds transfer (EFT) card information, financial card information, the like, or combinations thereof. The shopper may have previously entered the data via a website or any other suitable manner. A web server for the website may receive entry of the transaction data by the shopper. In another example, the transaction data may be entered manually by a user or retail personnel at the shopper terminal. In this example, the shopper terminal 100 may communicate the data to the remote computing device for storage and subsequent access when a purchase transaction is initiated.

The method of FIG. 2 includes conducting 206 the purchase transaction at the shopper terminal based on the transaction data. Continuing the aforementioned example, the transaction data may be used for automatically entering information for the purchase transaction. This automatic entry of the transaction data may be beneficial, for example, because it can expedite the purchase transaction. In this way, the shopper does not have to manually enter the information into the shopper terminal 100 to thereby reduce the time needed to conduct the purchase transaction.

In accordance with embodiments, the transaction data may include photographic data for verifying the shopper. For example, photographic data of a shopper having a loyalty program card. The photographic data may be stored at the shopper terminal 100 or a server accessible by the shopper terminal 100. The photographic data may be associated with the loyalty program identifier of the shopper. Subsequently, when the shopper proceeds to the shopper terminal 100 for conducting a purchase transaction, the shopper terminal 100 may receive the loyalty program identifier as disclosed herein. In response to receipt of the loyalty program identifier, the shopper terminal 100 may initiate a process for capturing an image of the shopper for comparison to the photographic data. For example, the user interface 104 may prompt the user with instructions for capturing an image if the shopper is buying an age restricted item. Subsequently, an image capture device 106 (e.g., a camera) may capture an image of the shopper. The purchase transaction manager 102 may verify an identity of the shopper based on the captured image and the photographic data. For example, the purchase transaction manager 102 may implement an identity verification technique to compare the captured image to the photographic data for confirming the identity of the shopper. In response to verifying the identity of the shopper, the shopper terminal 100 may permit purchase of an age restricted item in a suitable manner. In response to not verifying the identity of the shopper, the shopper terminal 100 may prevent purchase of the age restricted item and/or notify store personnel in a suitable manner.

In accordance with embodiments, the transaction data may specify an age for verifying the shopper. The purchase transaction may include capture of an image of the shopper (e.g., by the image capture device 106). The purchase transaction manager 102 may verify an identity of the shopper based on the captured image and the age specified by the transaction data. Verification may include determining whether the shopper appears in the captured to match the specified age. In response to verifying the age of the shopper, the shopper terminal 100 may permit purchase of an age restricted item in a suitable manner. In response to not verifying the age of the shopper, the shopper terminal 100 may prevent purchase of the age restricted item and/or notify store personnel in a suitable manner.

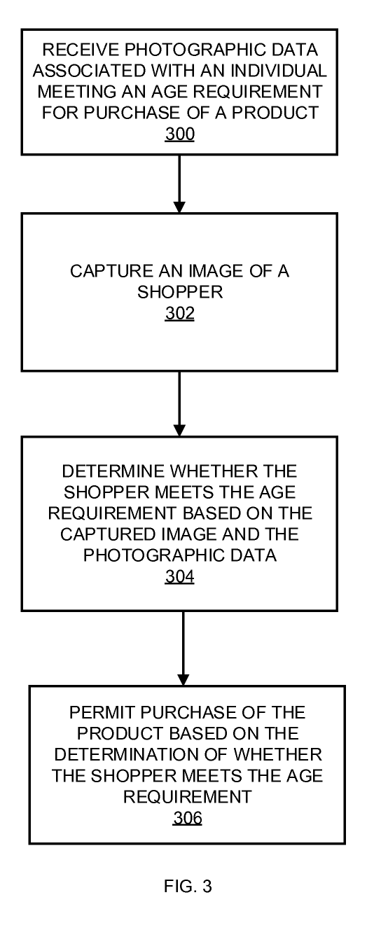

FIG. 3 illustrates a flow chart of an example method for using transaction data associated with loyalty program identifier to conduct a purchase transaction in accordance with embodiments of the present invention. In this example, the method is described as being implemented by the purchase transaction manager 102 of the shopper terminal 100, although it should be recognized that the method may be implemented by any suitable computing device.

Referring to FIG. 3, the method includes receiving 300 photographic data associated with an individual meeting an age requirement for purchase of a product. For example, the photographic data may be part of transaction data stored at the shopper terminal 100 or a remote server. The photographic data may be accessed by the purchase transaction manager 102 in response to initiation of a purchase transaction at the shopper terminal 100.

The method of FIG. 3 includes capturing 302 an image of a shopper. Continuing the aforementioned example, the image capture device 106 may be utilized to capture an image of a shopper. Further, the method includes determining 304 whether the shopper meets the age requirement based on the captured image and the photographic data. For example, the purchase transaction manager 102 may determine whether the shopper meets the age requirement based on the captured image and the photographic data.

The method of FIG. 3 includes permitting 306 purchase of the product based on the determination of whether the shopper meets the age requirement. Continuing the aforementioned example, the purchase transaction manager 102 may permit purchase of the product based on the determination of whether the shopper meets the age requirement. Further, the purchase transaction manager 102 may conduct a purchase transaction for the product in response to the determining that the shopper meets the age requirement.

In an example, photographic data of the shopper may be received by using a scanner to scan an identification card of the user. For example, the identification card may include a photograph of the individual and birthdate information. The purchase transaction manager 102 may determine an age of the individual based on the birthdate information. Further, in an example, the purchase transaction manager 102 may determine whether the shopper meets the age requirement based on the determined age, the photograph, and the capture image. In another example, the purchase transaction manager 102 may determine whether the shopper meets the age requirement comprises determining whether an identity of the individual in the photograph matches the shopper in the captured image. The purchase transaction manager 102 may permit purchase of the product in response to determining that the identity of the individual in the photograph matches the shopper in the captured image and the age required for purchase of the product meets the birthdate information.

In accordance with embodiments, an integrated face and ID scanner and a rewards website may be provided. The scanner and rewards website may be used for receiving personalized information and data about a shopper for reducing the time needed for the overall self-checkout process. Based on the received information and data, a shopper can be identified and transaction data as disclosed herein can be used more efficiently for improving the purchase transaction. As a result, throughput at a lane can be increased, to thereby increase the overall throughput at a store. In an example, the face scanner on a lane can integrate with an ID scanner at a kiosk with personalization set in a rewards website, to speed up the self-checkout transaction. In an example, a rewards website is provided allows for user entering personalization information, such as paper less receipts, ADA (accessibility mode), preferred language, EFT card information, and the like. Any updates to personalized information made by a user in this website can trickle down from a centralized web server to the lane through database replication. A user can log into this website using the loyalty/rewards card information.

In accordance with embodiments, a kiosk or shopper terminal may have an ID scanner. Further, the shopper terminal or server may store a database of valid IDs acceptable for age verification. This database, for example, can contain valid passport templates for various countries and the drivers license templates for various states. The database can contain the locations of image, date of birth, expiration date, hologram identifiers, and/or the like within the passport or drivers license. The user can log into this shopper terminal using the same credentials they used for logging into the website. In an example, the shopper terminal having an ID scanner may implement an OCR algorithm technique for reading date of birth and expiration dates of the passport or the drivers license. The shopper terminal may have an image matching algorithm that can match two images with a certain tolerance for weight, age, complexion, and/or the like. In another example, the shopper terminal may have an object/volume modeling algorithm operable to determine the distance from which a face is scanned, mapping it to the same size as the image from ID. In these ways, the identity of the shopper may be verified.

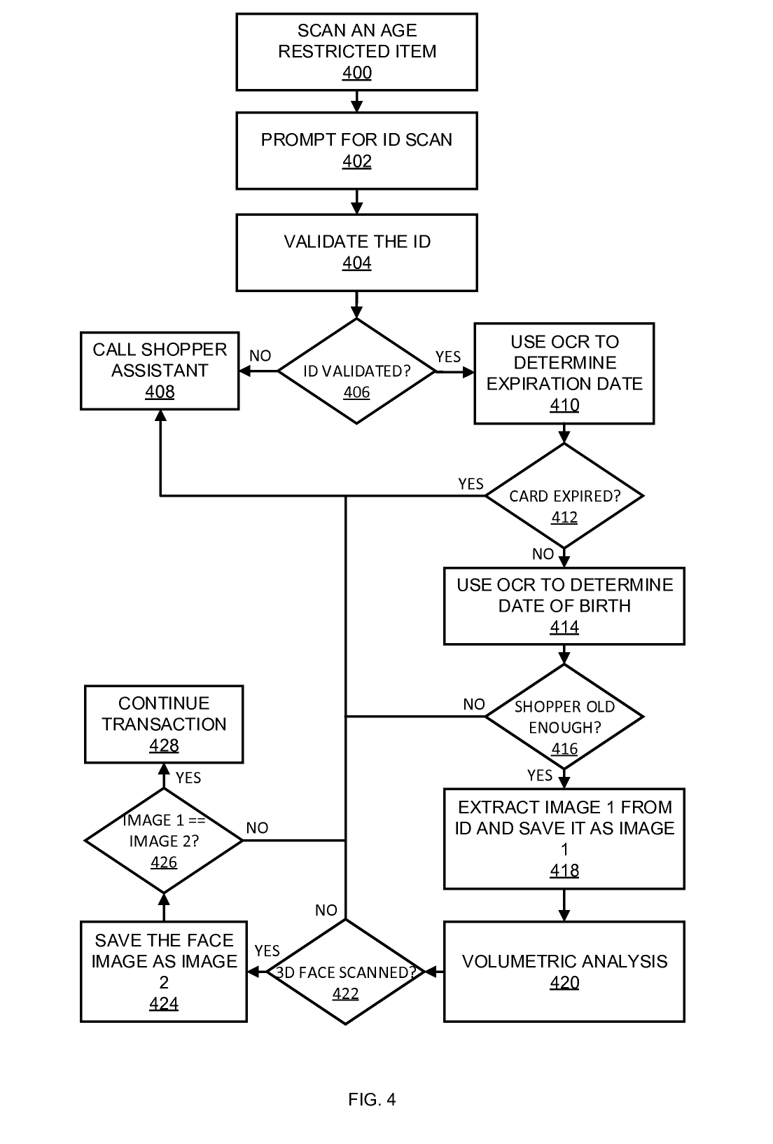

FIG. 4 illustrates a flow chart of an example method in accordance with embodiments of the present invention. In this example, the method is described as being implemented by the purchase transaction manager 102 of the shopper terminal 100, although it should be recognized that the method may be implemented by any suitable computing device.

Referring to FIG. 4, the method includes scanning 400 an age restricted item. For example, initially a shopper may interact with the shopper terminal 100 (e.g., a kiosk) and scan an age restricted item, such as a tobacco product. The method may include prompting 402 for an ID scan. For example, in response to scanning the age restricted item, the shopper terminal 100 may display a request for the shopper to scan his or her ID. In this example, a shopper may use an ID scanner of the shopper terminal 100 for scanning an ID card.

The method of FIG. 4 includes validating 404 the ID. For example, the shopper terminal 100 may access a database, such as a database of a remote server, having information for validating the ID. For example, the shopper terminal 100 may apply an OCR algorithm that extracts an expiration date and date of birth from the ID and may save it in the database along with other information associated with a customer loyalty program. The method includes determining 406 whether the ID is validated. In response to determining that the ID is not validated, a shopper assistant is called (block 408).

In response to determining that the ID is validated, the method includes using 410 an OCR algorithm to determine an expiration date on the ID. Further, the method includes determining 412 whether the card is expired based on a comparison of the expiration date and a current date. In response to determining that the card is expired, a shopper assistant may be called (block 408).

In response to determining that the card is not expired, the method includes using 414 an OCR algorithm to determine a date of birth on the ID. Further, the method includes determining 416 whether the shopper is old enough for purchase of the age restricted item based on the date of birth. In response to determining that the shopper is not old enough, a shopper assistant may be called (block 408). In response to determining that the shopper is old enough, an image including the shopper's face may be extracted from the ID and saved (block 418). Subsequently, a volumetric analysis 420 may be implemented to determine (block 422) whether a face is in the image and not another 2D image. In response to determining that a 3D face is not scanned, a shopper assistant may be called (block 408). In response to determining that a 3D face is scanned, the face image may be saved (block 424).

The method includes determining 426 whether the face image scanned from the ID matches a captured image of the shopper. In response to determining that the images do not match, a shopper assistant may be called (block 408). In response to determining that the image match, the purchase transaction may continue (block 428) for purchase of the age restricted item.

In an example scenario, a shopper may log into a rewards website of a retailer. By use of the website, the shopper may set all levels of personalized information, such as preferred language, accessibility mode, paper less receipts, EFT card information, and/or the like. Subsequently, each time a customer conducts a self-checkout transaction, he or she may scan a loyalty card associated with the rewards program and the set personalization information is applied to the purchase transaction at a shopper terminal. The information may be applied immediately because the web server back end database can replicate the information to a database of the shopper terminal. Both databases can share the same information (e.g., it may be a subset).

When the user has to buy an age restricted item, the shopper terminal can prompt the customer to stand at a fixed distance from the lane and take a photo using the face scanner camera. The shopper terminal image matching algorithm can match the image from the stored and validated ID to the image of the face. If the expiration date, date of birth and images are validated by comparison, the customer can continue to purchase the age restricted item. Once finished scanning all items, the customer can touch the “Finish and Pay” button and the lane can process EFT information saved in the database.

In accordance with embodiments, age verification for a self-checkout transaction are provided. As a result, the need of a shopper assistant during a self-checkout transaction may be eliminated or reduced. The automated face and ID scanner for self-checkout can make self-checkout process completely customer driven, provide personalization and privacy to a customer and expedite the self-checkout transactions during rush hours.

The face and ID scanner backend can have a database of valid IDs acceptable for age verification. This database for instance can contain valid passport templates for all the different countries and the driver's license for all states of a country. The database can contain the locations of image, date of birth, expiration date, hologram identifiers, and/or the like. The face and ID scanner backend can have an OCR algorithm, optical character recognition algorithm that can read the date of birth and expiration dates. The face and ID scanner backend can have an image matching algorithm that shall be able to match two images with a certain tolerance for weight, age, complexion, and the like. The face and ID scanner backend can have an object/volume modeling algorithm to determine the distance from which a face is scanned, mapping it to the same size as the image from ID.

An example method may include a customer scanning an age restricted item. He or she may be prompted at the monitor/screen asking if they would like to use the face/ID scanner or use shopper assistant's help. If they select face and ID scanner, the self-checkout machine can prompt them to select their form of ID. On this screen a customer can select the type of ID card that they are going to scan. Upon their selection database can identify the expected locations of image, D.O.B, expiration date, and hologram image expected for that ID with a certain tolerance. Then the next screen can ask them to scan their ID card. Upon a good scan, a beep sound can alert the customer that scan of ID is successful. The backend database can validate that the ID is valid and acceptable for the purchase. It accomplishes so by first validating that the ID is a valid form of ID by checking its attributes in the database of valid IDs. If a match is found, it uses OCR to determine the expiration date. If the expiration date check is successful, it uses OCR again to validate date of birth. If the whole sequence of three tests is successful, the self-checkout machine can store the image from the ID and save it as the first image to be matched. Subsequently, the self-checkout machine shall prompt a user to scan their face. A user shall be able to see their face on the self-checkout screen while it is being scanned/photographed. The self-checkout machine can save this face scan as the second image to be matched. The object modeling algorithm shall have the ability to map the size of face to the size of image. It can always have a mechanism to identify that a real face is scanned and not a photograph. To do this there should be a recommendation of a fixed distance between scanner and face. Then the object modeling can identify that it is a real face scan by checking that the size of face falls within the average human face size (e.g., 7-12 inches). An image comparison is done using the image matching algorithm. There can be a certain percentage of tolerance for image comparison to allow for variations in age, weight and complexion over a period of time. If the two images match, the user can be prompted to continue with their transaction, otherwise the shopper assistant can be notified to assist the purchase.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
initiating a purchase transaction at a shopper terminal;
receiving, at the shopper terminal, a loyalty program identifier of a shopper;
associating the loyalty program identifier with transaction data for the shopper; and
conducting the purchase transaction at the shopper terminal based on the transaction data.

2. The method of claim 1, wherein receiving the loyalty program identifier comprises scanning a loyalty program card including the loyalty program identifier.

3. The method of claim 1, further comprising receiving, at the shopper terminal, the transaction data from a computing device.

4. The method of claim 3, wherein the computing device is a web server, and
wherein the method further comprises receiving, at the web server, entry of the transaction data by the shopper.

5. The method of claim 1, wherein associating the loyalty program identifier comprises performing a lookup in a database based on the loyalty program identifier to retrieve the transaction data for the shopper.

6. The method of claim 1, wherein the transaction data includes one of preferred language information, accessibility mode, receipt information, electronic funds transfer (EFT) card information, and financial card information.

7. The method of claim 1, wherein conducting the purchase transaction comprises using the transaction data to automatically enter information for the purchase transaction.

8. The method of claim 7, wherein the shopper terminal comprises a user interface for manual entry of the transaction data.

9. The method of claim 1, wherein the transaction data comprises photographic data for verifying the shopper, and
wherein conducting the purchase transaction comprises:
capturing an image of the shopper; and
verifying an identity of the shopper based on the captured image and the photographic data.

10. The method of claim 1, wherein the transaction data comprises an age for verifying the shopper, and
wherein conducting the purchase transaction comprises:
capturing an image of the shopper; and
verifying an identity of the shopper based on the captured image and the age.

11. A method comprising:
at a shopper terminal:
receiving photographic data associated with an individual meeting an age requirement for purchase of a product;
capturing an image of a shopper;
determining whether the shopper meets the age requirement based on the captured image and the photographic data; and
permitting purchase of the product based on the determination of whether the shopper meets the age requirement.

12. The method of claim 11, further comprising conducting a purchase transaction for the product in response to the determining that the shopper meets the age requirement.

13. The method of claim 11, wherein receiving photographic data comprises scanning an identification card including a photograph of the individual and birthdate information.

14. The method of claim 13, further comprising determining an age of the individual based on the birthdate information.

15. The method of claim 14, wherein determining whether the shopper meets the age requirement comprises determining whether the shopper meets the age requirement based on the determined age, the photograph, and the capture image.

16. The method of claim 13, wherein determining whether the shopper meets the age requirement comprises determining whether an identity of the individual in the photograph matches the shopper in the captured image.

17. The method of claim 16, wherein permitting purchase of the product comprises permitting purchase of the product in response to determining that the identity of the individual in the photograph matches the shopper in the captured image and the age required for purchase of the product meets the birthdate information.

18. A system comprising:
at least one processor and memory configured to:
initiate a purchase transaction at a shopper terminal;
receive, at the shopper terminal, a loyalty program identifier of a shopper;
associate the loyalty program identifier with transaction data for the shopper; and
conduct the purchase transaction at the shopper terminal based on the transaction data.

19. The system of claim 18, wherein the at least one processor and memory are configured to scan a loyalty program card including the loyalty program identifier.

20. The system of claim 18, wherein the at least one processor and memory are configured to receive, at the shopper terminal, the transaction data from a computing device.

21. The system of claim 20, wherein the computing device is a web server, and
wherein the at least one processor and memory are configured to receive, at the web server, entry of the transaction data by the shopper.

22. The system of claim 18, wherein the at least one processor and memory are configured to perform a lookup in a database based on the loyalty program identifier to retrieve the transaction data for the shopper.

23. The system of claim 18, wherein the transaction data includes one of preferred language information, accessibility mode, receipt information, electronic funds transfer (EFT) card information, and financial card information.

24. The system of claim 18, wherein the at least one processor and memory are configured to use the transaction data to automatically enter information for the purchase transaction.

25. The system of claim 24, wherein the shopper terminal comprises a user interface for manual entry of the transaction data.

26. The system of claim 18, wherein the transaction data comprises photographic data for verifying the shopper, and
wherein the at least one processor and memory are configured to:
capture an image of the shopper; and
verify an identity of the shopper based on the captured image and the photographic data.

27. The system of claim 18, wherein the transaction data comprises an age for verifying the shopper, and
wherein the at least one processor and memory are configured to:
capture an image of the shopper; and
verify an identity of the shopper based on the captured image and the age.

28. A system comprising:
a shopper terminal at least one processor and memory configured to:
receive photographic data associated with an individual meeting an age requirement for purchase of a product;
capture an image of a shopper;
determine whether the shopper meets the age requirement based on the captured image and the photographic data; and
permit purchase of the product based on the determination of whether the shopper meets the age requirement.

29. The system of claim 28, wherein the at least one processor and memory are configured to conduct a purchase transaction for the product in response to the determining that the shopper meets the age requirement.

30. The system of claim 28, wherein the at least one processor and memory are configured to scan an identification card including a photograph of the individual and birthdate information.

31. The system of claim 30, wherein the at least one processor and memory are configured to determine an age of the individual based on the birthdate information.

32. The system of claim 31, wherein the at least one processor and memory are configured to determine whether the shopper meets the age requirement based on the determined age, the photograph, and the capture image.

33. The system of claim 30, wherein the at least one processor and memory are configured to determine whether an identity of the individual in the photograph matches the shopper in the captured image.

34. The system of claim 33, wherein the at least one processor and memory are configured to permit purchase of the product in response to determining that the identity of the individual in the photograph matches the shopper in the captured image and the age required for purchase of the product meets the birthdate information.

35. A computer program product comprising a computer readable storage medium having program instructions embodied therewith, the program instructions readable by a computing device to cause the computing device to:
initiate, by the computing device, a purchase transaction at a shopper terminal;
computer readable program code configured to receive, at the shopper terminal, a loyalty program identifier of a shopper;
associate, by the computing device, the loyalty program identifier with transaction data for the shopper; and
conduct, by the computing device, the purchase transaction at the shopper terminal based on the transaction data.

36. A computer program product comprising a computer readable storage medium having program instructions embodied therewith, the program instructions readable by a computing device to cause the computing device to:
receive, by the computing device, photographic data associated with an individual meeting an age requirement for purchase of a product;
capture, by the computing device, an image of a shopper;
determine, by the computing device, whether the shopper meets the age requirement based on the captured image and the photographic data; and
permit, by the computing device, purchase of the product based on the determination of whether the shopper meets the age requirement.
